(19) United States
(12) Patent Application Publication
(10) Pub. No.: US 2010/0216421 A1
(43) Pub. Date: Aug. 26, 2010

(54) METHODS AND APPARATUS FOR PROVIDING EMERGENCY ALERTS IN A COMMUNICATION NETWORK

(75) Inventor: Chih-Ping Hsu, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/389,637

(22) Filed: Feb. 20, 2009

(51) Int. Cl. H04M 11/04

(52) U.S. Cl. 455/404.1

(57) ABSTRACT

Methods and apparatus for providing emergency alerts in a communication network. In an aspect, a method includes transmitting an emergency alert message as part of a broadcast message, transmitting a configuration update indicating that the broadcast message is available, and transmitting a paging message, indicating that the configuration update is available. An apparatus includes broadcast logic configured to transmit an emergency alert message as part of a broadcast message, configuration logic configured to transmit a configuration update indicating that the broadcast message is available, and paging logic configured to transmit a paging message indicating that the configuration update is available. In an aspect, an apparatus includes means for receiving a paging message, indicating that a configuration update is available, means for receiving the configuration update indicating that a broadcast message is available, and means for receiving the broadcast message comprising an emergency alert message.

### BACKGROUND

1. Field

The present application relates generally to the operation of wireless communication systems, and more particularly, to methods and apparatus for providing emergency alerts in a communication network.

2. Background

Emergency alert systems enable network operators to communicate alert messages to network users in the event of an emergency. For example, transmitted alert messages may alert users to natural disasters, terrorist attacks or other types of emergency situations.

It is desirable to have an emergency alert system that meets a variety of criteria so as to efficiently deliver alert messages while minimizing the impact on the network and user devices. For example, such a system should be reliable and have a fast response time so as to deliver alert messages in an expedient manner. From the network perspective, the system should minimize the impact on network capacity, be compatible with current network standards, and allow normal network services to be maintained without interruption. From the device perspective, the system should consume very low power and be compatible with changes and advances in user equipment. Unfortunately, conventional systems fail to adequately meet the above requirements.

Therefore, what is needed is a mechanism that operates to overcome the deficiencies associated with conventional systems to provide emergency alerts in a communication network.

### SUMMARY

In one or more aspects, an emergency alert system, comprising methods and apparatus, is provided that operates to provide emergency alerts in a communication network.

In an aspect, a method is provided for an emergency alert in a communication network. The method comprises transmitting an emergency alert message as part of a broadcast message, transmitting a configuration update indicating that the broadcast message is available for reception, and transmitting a paging message, wherein the paging message indicates that the configuration update is available for reception.

In an aspect, an apparatus is provided for an emergency alert in a communication network. The apparatus comprises broadcast logic configured to transmit an emergency alert message as part of a broadcast message, configuration logic configured to transmit a configuration update indicating that the broadcast message is available for reception, and paging logic configured to transmit a paging message, wherein the paging message indicates that the configuration update is available for reception.

In an aspect, an apparatus is provided for an emergency alert in a communication network. The apparatus comprises means for transmitting an emergency alert message as part of a broadcast message, means for transmitting a configuration update indicating that the broadcast message is available for reception, and means for transmitting a paging message, wherein the paging message indicates that the configuration update is available for reception.

In an aspect, a method is provided for receiving an emergency alert in a communication network. The method comprises receiving a paging message, wherein the paging message indicates that a configuration update is available for reception, receiving the configuration update, wherein the configuration update indicates that a broadcast message is available for reception, and receiving the broadcast message comprising an emergency alert message.

In an aspect, an apparatus is provided for receiving an emergency alert in a communication network. The apparatus comprises transceiver logic configured to receive a paging message, wherein the paging message indicates that a configuration update is available for reception, and processing logic configured to receive the configuration update, wherein the configuration update indicates that a broadcast message is available for reception, and to receive the broadcast message comprising an emergency alert message.

In an aspect, an apparatus is provided for receiving an emergency alert in a communication network. The apparatus comprises means for receiving a paging message, wherein the paging message indicates that a configuration update is available for reception, means for receiving the configuration update, wherein the configuration update indicates that a broadcast message is available for reception, and means for receiving the broadcast message comprising an emergency alert message.

Other aspects will become apparent after review of the hereinafter set forth Brief Description of the Drawings, Description, and the Claims.

### BRIEF DESCRIPTION OF THE DRAWINGS

The foregoing aspects described herein will become more readily apparent by reference to the following Description when taken in conjunction with the accompanying drawings wherein:

FIG. 1 shows an exemplary communication network that illustrates aspects of an emergency alert system;

FIG. 2 shows exemplary emergency alert transmission logic for use in aspects of an emergency alert system;

FIG. 3 shows an exemplary method for operating emergency alert transmission logic for use in aspects of an emergency alert system;

FIG. 4 shows exemplary emergency alert receiving logic for use in aspects of an emergency alert system;

FIG. 5 shows an exemplary method for operating emergency alert receiving logic for use in aspects of an emergency alert system;

FIG. 6 shows exemplary emergency alert transmission logic for use in aspects of an emergency alert system; and

FIG. 7 shows exemplary emergency alert receiving logic for use in aspects of an emergency alert system.

### DESCRIPTION

The following description describes aspects of an emergency alert system that operates to provide alert messages to devices on a network. For example, the system operates to allow a network server to page a plurality of devices on the network to indicate that a configuration update has occurred. In response to the page, the devices update their configuration information, and in doing so, determine that a broadcast/multicast is to be received. The received broadcast/multicast includes one or more emergency alert messages. Thus, the devices are able to receive the alert messages in a mechanism that is reliable, has a fast response, minimizes the impact on network capacity, is compatible with current network standards, and allows normal network services to be maintained without interruption. The system also results low power consumption at the devices and is compatible with changes and advances in device equipment.

In essence, the emergency alert system utilizes aspects of both communication networks and broadcast networks. For example, communication networks, such as cell phone networks, provide high accessibility and low power consumption through the use of paging channels. High accessibility is provided since most cell phone users leave their devices on all the time. However, utilizing only paging channels to pass emergency alerts would not be expedient and would severely impact system capacity. On the other hand, broadcast networks, can send a message to all users simultaneously with no additional cost. Unfortunately, in a broadcast network, it is difficult to know how many users are being reached at any one time. Thus, the system provides efficient emergency alerts by utilizing aspects of both communication networks and broadcast networks. For example, a paging mechanism is used to effectively reach a large number of users, and a broadcast mechanism is used to efficiently distribute emergency information.

Therefore, in various aspects, the emergency alert system operates to utilize the normal paging monitoring activity that happens in a device to provide an efficient mechanism to distribute alert messages. It should also be noted, however, that although the system utilizes normal paging mechanisms, devices do not access the network in response, which would increases the system load. Instead, devices receive a broadcast message, which minimizes the impact on the system load,

The system is especially well suited for use in wireless network environments, but may be used in any type of network environment, including but not limited to, communication networks, public networks, such as the Internet, private networks, such as virtual private networks (VPN), local area networks, wide area networks, long haul network, or any other type of network.

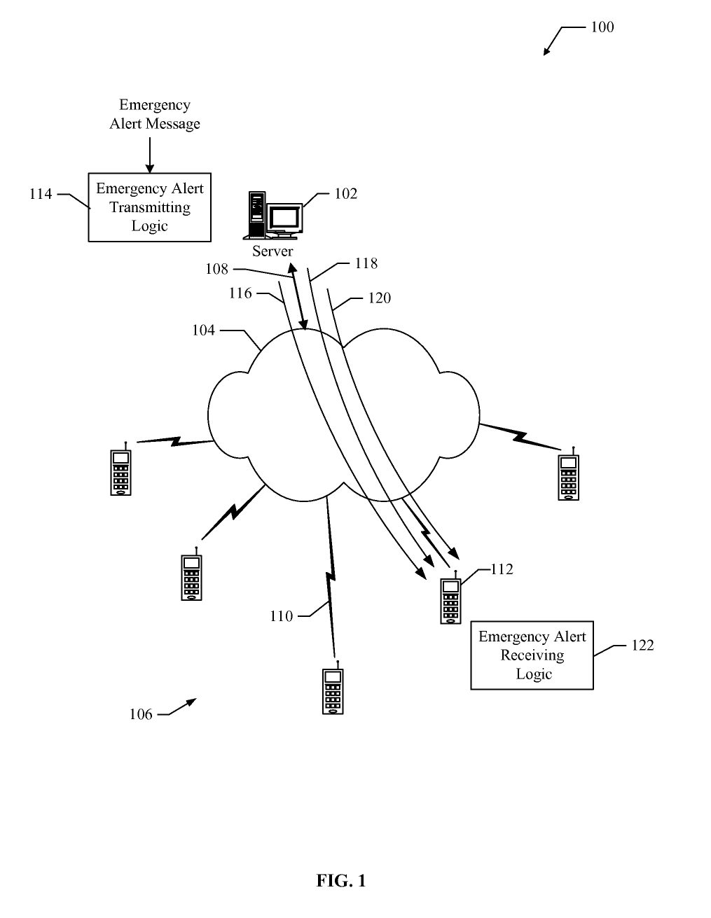

FIG. 1 shows a network 100 that illustrates aspects of an emergency alert system. The network 100 comprises server 102, network 104, and a plurality of devices shown generally at 106. The network 104 may be any type and/or combination of wired and wireless networks that allow data to be transmitted between the server 102 and the devices 106. Thus, the primary function of the network 104 is to facilitate communication between devices. The server 102 is coupled to the network 104 via the communication link 108, which may be any type of wired and/or wireless communication link that allows the server 102 to communicate with the network 104. The devices 106 comprise a mobile telephone, PDA, notebook computer, pager, email device, or any other type of device that is operable to communicate with the network 104. The devices 106 are in communication with the network 104 via wireless communication links 110, which allows data to be wirelessly transmitted between the network 104 and the devices 106. In an aspect, the wireless communication links 110 comprises forward communication channels, reverse communication channels, paging channels, control channels, broadcast/multicast channels and any other type of communication channel that may be used to communicate information between the network 104 and the devices 106.

It should also be noted that aspects of the emergency alert system are suitable for use with virtually any number of devices that communicate with the network 104 via wired and/or wireless communication links. For the purpose of this description, the operation of the device 112 will be described in detail; however aspects of the emergency alert system are equally applicable to all the devices shown generally at 106.

The server 102 comprises emergency alert transmission logic 114. During operation, the server 102 receives or otherwise obtains an emergency alert message that is to be transmitted to the devices 106 as part of an emergency alert. For example, the alert message describes an alert related to a natural disaster, terrorist attack, or other emergency condition.

The emergency alert transmission logic 114 operates to receive the alert message and generate a series of messages so as to efficiently distribute an emergency alert message to the devices 106. In an aspect, the emergency alert transmission logic 114 operates to transmit a page 116 to the devices 106. The page 116 is transmitted using a paging channel or other suitable paging mechanism. The page 116 is formatted so as to indicate to the devices that a system configuration update has been performed. The emergency alert transmission logic 114 then transmits one or more transmission frames 118 that include a system configuration update that updates system configuration information. For example, in a UMTS network, the system configuration information is contained in a master information block (MIB) and/or a system information block (SIB). Thus, in such a case, information contained in the MIB/SIB is configured to indicate to the devices 106 that a broadcast/multicast will occur and that the devices should enable themselves to receive the broadcast/multicast transmission. The emergency alert transmission logic 114 then causes a broadcast/multicast 120 to occur which includes the alert message so that devices tuned to receive the broadcast/multicast will receive the alert message. It should be noted that the configuration update 118 and the broadcast/multicast 120 are the same for all the devices 106. Thus, there is no additional cost to send these messages to multiple users.

The operation of the devices 106 is described with reference to the device 112. To reduce power consumption, the device 112 is not enabled to receive broadcast transmissions. Thus, the broadcast/multicast channel logic at the device 112 is in an inactive state. The device 112 comprises emergency alert receiving logic 122 that operates to receive the page 116. The emergency alert receiving logic 122 decodes the page 116 to determine that a configuration change has occurred. The emergency alert receiving logic 122 then updates its configuration information. For example, the transmission frames 118 are received and configuration information in the transmission frame is decoded and saved at the device 112. The configuration information identifies a broadcast/multicast transmission and indicates that the device 112 is to enable its broadcast/multicast transmission channel to receive the broadcast/multicast transmission. The emergency alert receiving logic 122 then receives the broadcast/multicast 120 which contains the emergency alert message. The emergency alert message is then processed by the device 112 so that any suitable emergency activity can be performed.

Thus, in one or more aspects, an emergency alert system is provided that operates to provide emergency alert messages to devices in a communication network. It should be noted that the network 100 is just one implementation and that other implementations are possible within the scope of the aspects.

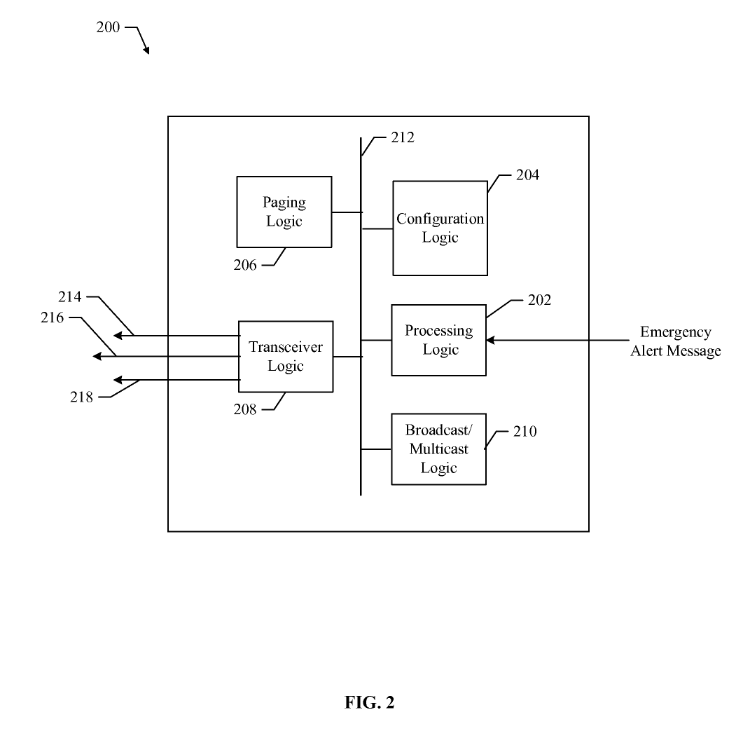

FIG. 2 shows exemplary emergency alert transmission logic 200 for use in aspects of an emergency alert system. For example, the emergency alert transmission logic 200 is suitable for use as the emergency alert transmission logic 114 shown in FIG. 1. The emergency alert transmission logic 200 comprises processing logic 202, configuration logic 204, paging logic 206, transceiver logic 208, and broadcast/multicast logic 210 all coupled to a data bus 212. It should be noted that the emergency alert transmission logic 200 is just one implementation and that other implementations are possible within the scope of the aspects.

The transceiver logic 208 comprises hardware and/or hardware executing software that operates to allow the emergency alert transmission logic 200 to communicate data or other information over a network with remote devices or systems. For example, in an aspect, the transceiver logic 208 is operable to transmit information to network devices over a paging channel 214. The transceiver logic 208 is also operable to transmit configuration information to networked devices using one or more transmission frames that are part of a distribution waveform transmitted over a forward link 216. The transceiver logic 208 is also operable to broadcast/multicast information over a broadcast channel 218. The term “broadcast” is used herein to mean a broadcast, multicast or other transmission over a network that can be received by two or more devices.

The paging logic 206 comprises hardware and/or hardware executing software that operates to generate paging messages for transmission over the paging channel 214. For example, the paging logic 206 typically operates to initiate dedicated communications to a specific device. In an aspect, the paging logic 206 generates a paging message indicating that a configuration update has occurred. The generated paging message is transmitted to devices on a communication network by the transceiver logic 208 using the paging channel 214.

In one or more aspects, the processing logic 202 comprises at least one of a CPU, processor, gate array, hardware logic, memory elements, and/or hardware executing software. Thus, the processing logic 202 comprises logic to execute machine-readable instructions and to control one or more other functional elements of the emergency alert transmission logic 200.

In an aspect, the processing logic 202 operates to receive one or more emergency alert messages that are to be distributed to devices on a communication network. For example, in an aspect, the emergency alert messages describe emergency situations, such as a natural disaster, terrorist attack or other emergency conditions.

The configuration logic 204 comprises at least one of a CPU, processor, gate array, hardware logic, memory elements, and/or hardware executing software. The configuration logic 204 generates configuration information that may be transmitted to devices on a communication network. For example, the configuration information is transmitted in one or more transmission frames that are part of a distribution waveform that is transmitted over the forward link 216 by the transceiver logic 208. The configuration logic 204 is operable to set the configuration information so as to indicate that a device receiving the configuration information is to enable itself to receive broadcast/multicast transmissions.

The broadcast/multicast logic 210 comprises at least one of a CPU, processor, gate array, hardware logic, memory elements, and/or hardware executing software. The broadcast/multicast logic 210 is operable to generate broadcast/multicast messages. In an aspect, the broadcast/multicast logic 210 operates to receive the emergency alert message from the processing logic 202 for inclusion in a broadcast/multicast message that is transmitted over the broadcast/multicast channel 218 by the transceiver logic 208.

During operation, the processing logic 202 receives one or more emergency alert messages for transmission to devices on a communication network. The processing logic 202 then passes the emergency alert message to the broadcast/multicast logic 210 which includes the message in information to be broadcast/multicast over the communication network. This information is then passed to the transceiver logic 208 which broadcast/multicasts the information over the broadcast/multicast channel 218.

The processing logic 202 then signals the configuration logic 204 to generate configuration information to be transmitted to devices on a communication network. The configuration information notifies the devices to enable themselves to receive a broadcast/multicast transmission. The configuration logic 204 then passes the configuration information to the transceiver logic 208 for transmission in one or more transmission frames over the forward link channel 216.

The processing logic 202 signals the paging logic 206 to generate a paging message to indicate that a configuration update has occurred. The paging logic 206 generates the paging message and passes it for the transceiver logic 208 for transmission over the paging channel 214.

In an aspect, the emergency alert system comprises a computer program product having one or more program instructions (“instructions”) or sets of “codes” stored or embodied on a machine-readable medium. When the codes are executed by at least one processor, for instance, a processor at the processing logic 202, their execution causes the processor to provide the functions of the emergency alert system described herein. For example, the machine-readable medium comprises a floppy disk, CDROM, memory card, FLASH memory device, RAM, ROM, or any other type of memory device or machine-readable medium that interfaces to emergency alert transmission logic 200. In another aspect, the sets of codes may be downloaded into the emergency alert transmission logic 200 from an external device or communication network resource. The sets of codes, when executed, cause the emergency alert transmission logic 200 to provide aspects of an emergency alert system as described herein.

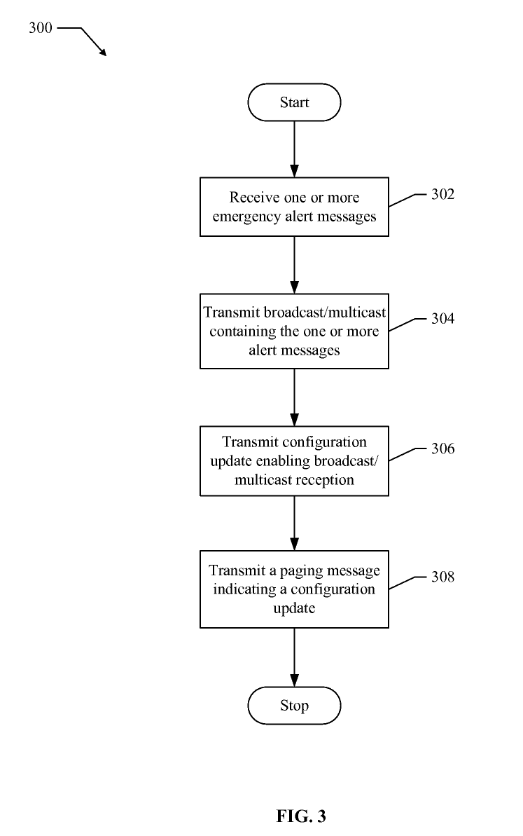

FIG. 3 shows an exemplary method 300 for operating emergency alert transmission logic for use in aspects of an emergency alert system. For clarity, the method 300 is described below with reference to the emergency alert transmission logic 200 shown in FIG. 2. In an aspect, the processing logic 202 executes one or more sets of codes to control the emergency alert transmission logic 200 to perform the functions described below.

At block 302, one or more emergency alert messages are received. In an aspect, the processing logic 202 receives the emergency alert messages directly or through a connection to a remote device.

At block 304, a broadcast/multicast is transmitted that includes the one or more emergency alert messages. In an aspect, the processing logic 202 signals the broadcast/multicast logic 210 to generate broadcast/multicast information that includes the one or more alert messages. The broadcast/multicast information is passed to the transceiver logic 208 and is broadcast/multicast to the devices on the communication network using the broadcast channel 218.

At block 306, a configuration update is transmitted to devices on a communication network. In an aspect, the configuration logic 204 generates the configuration information which is transmitted by the transceiver logic 208 as part of a distribution waveform on the forward link 216. In an aspect, the processing logic 202 signals the configuration logic 204 to generate the configuration message and transmit it to the devices.

At block 308, a paging message is transmitted to devices on a communication network. In an aspect, the paging logic 206 generates the paging message and the transceiver logic 208 transmits the paging message over a paging channel 214 to the devices. In an aspect, the paging message includes an indicator or bit indicating that a configuration update has occurred. In an aspect, the processing logic 202 signals the paging logic 206 to generate and transmit the paging message.

Therefore, the method 300 operates to transmit emergency alert messages for use in aspects of an emergency alert system. It should be noted that the method 300 is just one implementation and that the operations of the method 300 may be rearranged or otherwise modified within the scope of the various aspects. Thus, other implementations are possible with the scope of the various aspects described herein.

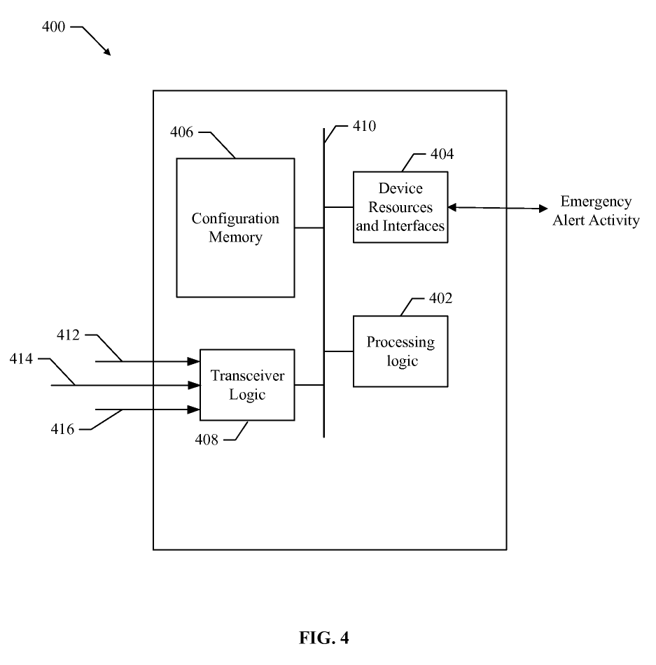

FIG. 4 shows exemplary emergency alert receiving logic 400 for use in aspects of an emergency alert system. For example, the emergency alert receiving logic 400 is suitable for use as the emergency alert receiving logic 120 shown in FIG. 1. The emergency alert receiving logic 400 comprises processing logic 402, device resources and interfaces 404, configuration memory 406, and transceiver logic 408 all coupled to a data bus 410. It should be noted that the emergency alert receiving logic 400 is just one implementation and that other implementations are possible within the scope of the aspects.

The processing logic 402 comprises at least one of a CPU, processor, gate array, hardware logic, memory elements, and/or hardware executing software. Thus, the processing logic 402 generally comprises logic to execute machine-readable instructions and to control one or more other functional elements of the emergency alert receiving logic 400 via the data bus 410.

The device resources and interfaces 404 comprise hardware and/or hardware executing software to allow the emergency alert receiving logic 400 to communicate with internal and external systems. For example, internal systems may include mass storage systems, memory, display driver, modem, or other internal device resources. The external systems may include user interface devices, displays, keypad, printers, disk drives, or other local devices or systems. Thus, the device resources and interfaces 406 operate to allow alerts, notifications, or other emergency alert activities to be performed in any suitable fashion to alert a device user or perform some other function.

The configuration memory 406 comprises any suitable memory device configured to store parameters that are associated with the operation of a device on a communication network. For example, the parameters comprise device identifiers, subscription information, application information, such as types and versions, and any other parameters or related information. The configuration memory 406 comprises any suitable memory and may be accessed, updated, or otherwise modified by the processing logic 402.

The transceiver logic 408 comprises hardware and/or hardware executing software to allow the emergency alert receiving logic 400 to transmit and receive data and other information with external devices or systems. For example, the transceiver logic 408 is operable to receive pages via a paging channel 412. The transceiver logic 408 is also operable to receive configuration information in one or more transmission frames received over a forward link 414. The transceiver logic 408 is also operable to receive broadcast/multicast information over a broadcast/multicast channel 416. In an aspect, the broadcast/multicast information comprises emergency alert messages. In an aspect, the transceiver logic 408 disables the broadcast/multicast channel 416 so as to save power. The transceiver logic 408 activates the broadcast/multicast channel 416 when notified by the processing logic 402 to enable reception of broadcast/multicast information.

During operation, a paging message is received over the paging channel 412 by the transceiver logic 408. The received paging message is passed to the processing logic 402 where it is decoded to determine if a configuration update has occurred. If a configuration update has occurred, the processing logic 402 signals the transceiver logic 408 to receive configuration information in one or more transmission frames received over the forward link 414. The configuration information is stored in the configuration memory 406. The processing logic 402 decodes the configuration information to determine if a broadcast/multicast is to be received. If a broadcast/multicast is to be received, the processing logic 402 signals the transceiver logic 408 to enable the broadcast/multicast logic to receive the broadcast/multicast. The received broadcast/multicast includes one or more emergency alert messages. The processing logic 402 decodes the received emergency alert messages and controls the device interfaces and resources 404 to perform the appropriate alert activity in response to the received alert messages. It should also be noted that for a device already configured to receive broadcast/multicast transmissions, it will receive the alert message as well without processing of the paging message described above.

In an aspect, the emergency alert system comprises a computer program product having one or more program instructions (“instructions”) or sets of “codes” stored or embodied on a machine-readable medium. When the codes are executed by at least one processor, for instance, a processor at the processing logic 402, their execution causes the processor to provide the functions of the emergency alert system described herein. For example, the machine-readable medium comprises a floppy disk, CDROM, memory card, FLASH memory device, RAM, ROM, or any other type of memory device or machine-readable medium that interfaces to emergency alert receiving logic 400. In another aspect, the sets of codes may be downloaded into the emergency alert receiving logic 400 from an external device or communication network resource. The sets of codes, when executed, cause the emergency alert receiving logic 400 to provide aspects of an emergency alert system as described herein.

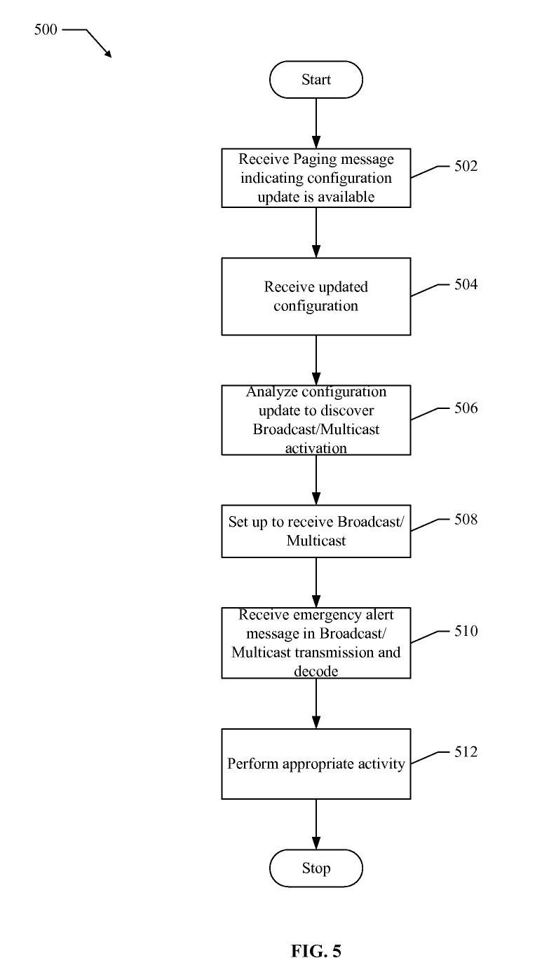

FIG. 5 shows an exemplary method 500 for operating emergency alert receiving logic for use in aspects of an emergency alert system. For clarity, the method 500 is described below with reference to the emergency alert receiving logic 400 shown in FIG. 4. In an aspect, the processing logic 402 executes one or more sets of codes to control the emergency alert receiving logic 400 to perform the functions described below.

At block 502, a paging message is received on a paging channel. In an aspect, the transceiver logic 408 receives the paging message over the paging channel 412. The paging message is passed to the processing logic 402 where it is decoded to determine if a configuration update has occurred. If the paging message indicates that a configuration update has occurred, the processing logic 402 operates to control the transceiver 408 to receive the configuration update.

At block 504, a configuration update is received in a transmission frame that is part of a distribution waveform received over the forward link 414. In an aspect, the transceiver logic 408 operates to receive the configuration information and passes it to the processing logic 402. The processing logic 402 operates to store the configuration information in the configuration memory 406.

At block 506, the configuration information is analyzed. In an aspect, the processing logic 402 analyzes the configuration information to determine whether a broadcast/multicast is to be received. If the configuration information indicates that a broadcast/multicast is to be received, the processing logic 402 operates to control the transceiver 408 to receive the broadcast/multicast.

At block 508, a broadcast/multicast is received. In an aspect, the broadcast/multicast is received over the broadcast/multicast channel 416 by the transceiver logic 408 and information contained in the broadcast/multicast is passed to the processing logic 402. In an aspect, broadcast/multicast logic at the transceiver logic 408 is disabled to save power. The processing logic 402 signals the transceiver logic 408 to enable the broadcast/multicast logic to receive the broadcast/multicast transmission.

At block 510, an emergency alert message is decoded from the information received in the broadcast/multicast. The alert message identifies one or more emergency conditions and any alert activity the processing logic 402 should perform.

At block 512, activity in response to the emergency alert message is performed. In an aspect, the processing logic 402 controls the device resources and interfaces 404 to perform any desired activity in response to receiving the emergency alert message. For example, any type of device indicator may be activated

Therefore, the method 500 operates to receive emergency alert messages for use in aspects of an emergency alert system. It should be noted that the method 500 is just one implementation and that the operations of the method 500 may be rearranged or otherwise modified within the scope of the various aspects. Thus, other implementations are possible with the scope of the various aspects described herein.

FIG. 6 shows exemplary emergency alert transmission logic 600 for use in aspects of an emergency alert system. For example, the emergency alert transmission logic 600 is suitable for use as the emergency alert transmission logic 112 shown in FIG. 1. In an aspect, the emergency alert transmission logic 600 is implemented by at least one integrated circuit comprising one or more modules configured to provide aspects of an emergency alert system as described herein. For example, in an aspect, each module comprises hardware and/or hardware executing software.

The emergency alert transmission logic 600 comprises a first module comprising means (602) for transmitting an emergency alert message as part of a broadcast message, which in an aspect comprises the broadcast logic 210. The emergency alert transmission logic 600 also comprises a second module comprising means (604) for transmitting a configuration update indicating that the broadcast message is available for reception, which in an aspect comprises the configuration logic 204. The emergency alert transmission logic 600 also comprises a third module comprising means (606) for transmitting a paging message, wherein the paging message indicates that the configuration update is available for reception, which in an aspect comprises the paging logic 206.

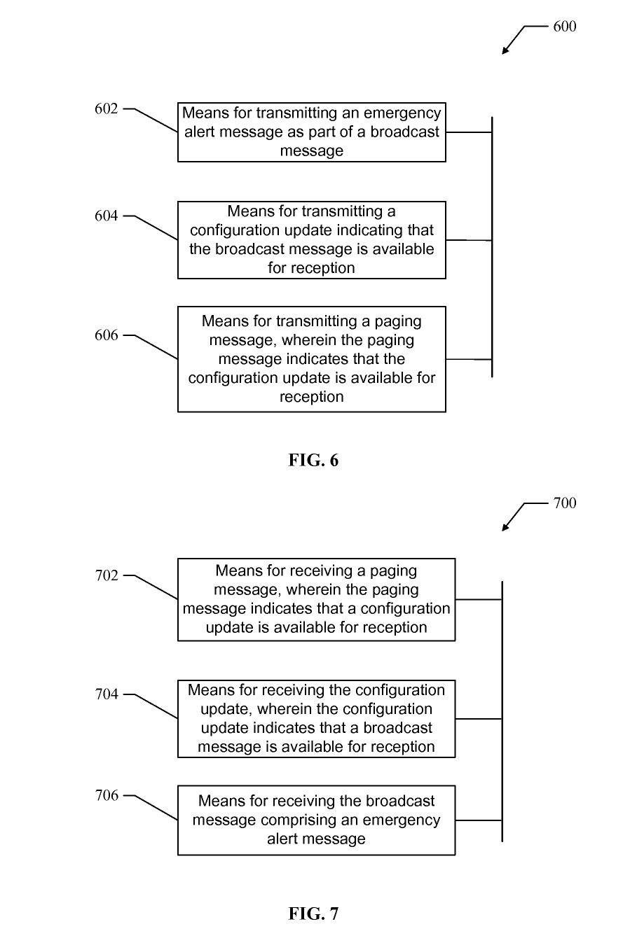

FIG. 7 shows exemplary emergency alert receiving logic 700 for use in aspects of an emergency alert system. For example, the emergency alert receiving logic 700 is suitable for use as the emergency alert transmission logic 120 shown in FIG. 1. In an aspect, the emergency alert receiving logic 700 is implemented by at least one integrated circuit comprising one or more modules configured to provide aspects of an emergency alert system as described herein. For example, in an aspect, each module comprises hardware and/or hardware executing software.

The emergency alert receiving logic 700 comprises a first module comprising means (702) for receiving a paging message, wherein the paging message indicates that a configuration update is available for reception, which in an aspect comprises the transceiver logic 408. The emergency alert receiving logic 700 also comprises a second module comprising means (704) for receiving the configuration update, wherein the configuration update indicates that a broadcast message is available for reception, which in an aspect comprises the processing logic 402. The emergency alert receiving logic 700 also comprises a third module comprising means (706) for receiving the broadcast message comprising an emergency alert message, which in an aspect comprises the processing logic 402.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a wireless communication device. In the alternative, the processor and the storage medium may reside as discrete components in a wireless communication device.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while aspects of an emergency alert system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method for providing an emergency alert in a communication network, the method comprising:
transmitting an emergency alert message as part of a broadcast message;
transmitting a configuration update indicating that the broadcast message is available for reception; and
transmitting a paging message, wherein the paging message indicates that the configuration update is available for reception.

2. The method of claim 1, further comprising generating the configuration update to indicate that the broadcast message is available for reception.

3. The method of claim 2, wherein said generating comprises generating at least one of a master information block (MIB) and a system information block (SIB) to indicate that the broadcast message is available for reception.

4. The method of claim 1, wherein said transmitting the configuration update comprises transmitting the configuration update in one or more transmission frames.

5. The method of claim 1, wherein said transmitting the paging message comprises transmitting the paging message over a paging channel.

6. An apparatus for providing an emergency alert in a communication network, the apparatus comprising:
broadcast logic configured to transmit an emergency alert message as part of a broadcast message;
configuration logic configured to transmit a configuration update indicating that the broadcast message is available for reception; and
paging logic configured to transmit a paging message, wherein the paging message indicates that the configuration update is available for reception.

7. The apparatus of claim 6, wherein said configuration logic is configured to generate the configuration update to indicate that the broadcast message is available for reception.

8. The apparatus of claim 7, wherein said configuration logic is configured to generate at least one of a master information block (MIB) and a system information block (SIB) to indicate that the broadcast message is available for reception.

9. The apparatus of claim 6, wherein said configuration logic is configured to transmit the configuration update in one or more transmission frames.

10. The apparatus of claim 6, wherein said paging logic is configured to transmit the paging message over a paging channel.

11. An apparatus for providing an emergency alert in a communication network, the apparatus comprising:
means for transmitting an emergency alert message as part of a broadcast message;
means for transmitting a configuration update indicating that the broadcast message is available for reception; and
means for transmitting a paging message, wherein the paging message indicates that the configuration update is available for reception.

12. The apparatus of claim 11, further comprising means for generating the configuration update to indicate that the broadcast message is available for reception.

13. The apparatus of claim 12, wherein said means for generating comprises means for generating at least one of a master information block (MIB) and a system information block (SIB) to indicate that the broadcast message is available for reception.

14. The apparatus of claim 11, wherein said means for transmitting the configuration update comprises means for transmitting the configuration update in one or more transmission frames.

15. The apparatus of claim 11, wherein said means for transmitting the paging message comprises means for transmitting the paging message over a paging channel.

16. A computer program product for providing an emergency alert in a communication network, the computer program product comprising:
a machine-readable medium encoded with codes executable to:
transmit an emergency alert message as part of a broadcast message;
transmit a configuration update indicating that the broadcast message is available for reception; and
transmit a paging message, wherein the paging message indicates that the configuration update is available for reception.

17. A server providing an emergency alert in a communication network, the server comprising:
an antenna;
broadcast logic coupled to the antenna and configured to transmit an emergency alert message as part of a broadcast message;
configuration logic coupled to the antenna and configured to transmit a configuration update indicating that the broadcast message is available for reception; and
paging logic coupled to the antenna and configured to transmit a paging message, wherein the paging message indicates that the configuration update is available for reception.

18. A method for receiving an emergency alert in a communication network, the method comprising:
receiving a paging message, wherein the paging message indicates that a configuration update is available for reception;
receiving the configuration update, wherein the configuration update indicates that a broadcast message is available for reception; and
receiving the broadcast message comprising an emergency alert message.

19. The method of claim 18, wherein said receiving comprises receiving the paging message over a paging channel.

20. The method of claim 18 wherein said receiving the configuration update comprises receiving the configuration update in one or more transmission frames.

21. The method of claim 20, wherein said receiving the configuration update comprises decoding at least one of a master information block (MIB) and a system information block (SIB) to determine that the broadcast message is available for reception.

22. The method of claim 18, further comprising performing an emergency activity in response to the emergency alert message.

23. An apparatus for receiving an emergency alert in a communication network, the apparatus comprising:
transceiver logic configured to receive a paging message, wherein the paging message indicates that a configuration update is available for reception; and
processing logic configured to receive the configuration update, wherein the configuration update indicates that a broadcast message is available for reception, and to receive the broadcast message comprising an emergency alert message.

24. The apparatus of claim 23, wherein said transceiver logic is configured to receive the paging message over a paging channel.

25. The apparatus of claim 23 wherein said processing logic is configured to receive the configuration update in one or more transmission frames.

26. The apparatus of claim 25, wherein said processing logic is configured to decode at least one of a master information block (MIB) and a system information block (SIB) to determine that the broadcast message is available for reception.

27. The apparatus of claim 23, further comprising device resources configured to perform an emergency activity in response to the emergency alert message.

28. An apparatus for receiving an emergency alert in a communication network, the apparatus comprising:
means for receiving a paging message, wherein the paging message indicates that a configuration update is available for reception;
means for receiving the configuration update, wherein the configuration update indicates that a broadcast message is available for reception; and
means for receiving the broadcast message comprising an emergency alert message.

29. The apparatus of claim 28, wherein said means for receiving comprises means for receiving the paging message over a paging channel.

30. The apparatus of claim 28 wherein said means for receiving the configuration update comprises means for receiving the configuration update in one or more transmission frames.

31. The apparatus of claim 30, wherein said means for receiving the configuration update comprises means for decoding at least one of a master information block (MIB) and a system information block (SIB) to determine that the broadcast message is available for reception.

32. The apparatus of claim 28, further comprising means for performing an emergency activity in response to the emergency alert message.

33. A computer program product for receiving an emergency alert in a communication network, the computer program product comprising:
a machine-readable medium encoded with codes executable to:
receive a paging message, wherein the paging message indicates that a configuration update is available for reception;
receive the configuration update, wherein the configuration update indicates that a broadcast message is available for reception; and
receive the broadcast message comprising an emergency alert message.

34. A device receiving an emergency alert in a communication network, the device comprising:
an antenna;
transceiver logic coupled to the antenna and configured to receive a paging message, wherein the paging message indicates that a configuration update is available for reception; and
processing logic configured to receive the configuration update, wherein the configuration update indicates that a broadcast message is available for reception, and to receive the broadcast message comprising an emergency alert message.
